(19) United States
(12) Patent Application Publication
(10) Pub. No.: US 2004/0129194 A1
(43) Pub. Date: Jul. 8, 2004

(54) Window assembly with privacy shade for a vessel

(76) Inventor: James W. Black, Tampa, FL (US)

Correspondence Address: C. DOUGLAS MCDONALD, CARLTON FIELDS, P.A., P. O. BOX 3239, TAMPA, FL, 33602, US

(21) Appl. No.: 10/335,616

(22) Filed: Jan. 2, 2003

(51) Int. Cl. E05F 1/00

(52) U.S. Cl. 114/117

(57) ABSTRACT

A window assembly for a vessel is disclosed having a frame, a window mounted within the frame with one surface of the window facing in an outward direction and another surface facing in an inward direction, with the assembly further including a pivotally movable cover extending over at least a substantial portion of the inward facing surface of the window and being selectively positionable for pivotal movement about a pivot axis between one position substantially blocking vision to the window and another position permitting generally unobstructed vision through the window.

### BACKGROUND OF THE INVENTION

This invention relates generally to a port or window assembly for a marine vessel or the like, and more particularly to such a port incorporating a selectively positionable cover to provide privacy.

Window assemblies for vessels or other structures are provided to permit the introduction of light into the vessel, and to permit viewing either from the vessel outwardly, or into the vessel. Such window assemblies may either be fixed or may be selectively openable to allow air into the vessel. In any event, most such window assemblies have no privacy cover incorporated into the assembly, but generally have required curtains or other additional structures to provide for privacy.

### SUMMARY OF THE INVENTION

It is an object of the present invention to provide a window assembly for a vessel that incorporates into the assembly, itself, a privacy shade that made be selectively positionable between a first position substantially blocking vision through the window and a second position permitting generally unobstructed vision through the window. To achieve these and other objects of the invention that will become apparent to those skilled in the art, this invention provides a window assembly for a vessel which comprises a frame of predetermined perimeter configuration, a window mounted within the frame, and having a perimeter configuration corresponding generally to the predetermined configuration, with one surface of the window facing in an outward direction and another surface facing in an inward direction, and a pivotally movable cover extending over at least a substantial portion of the inward facing surface of the window and being selectively positionable for pivotal movement about the pivot axis between a first position substantially blocking vision through the window and a second position permitting generally unobstructed vision through the window.

### BRIEF DESCRIPTION OF THE DRAWINGS

A particularly preferred embodiment of the invention of this apparatus will be described in detail below in connection with the drawings in which:

FIG. 1 shows the window assembly for a vessel according to the present invention, as seen from the inside direction with respect to the manner in which it would be mounted in a vessel;

FIG. 2 illustrates the window assembly of FIG. 1 as it would be seen on the outside, mounted to a vessel;

FIG. 3 is an exploded view of the components of the window assembly of FIGS. 1 and 2;

FIG. 4 illustrates the window assembly of FIG. 1 which the pivotally movable cover is moved to a position permitting generally unobstructed vision through the window; and

FIG. 5 illustrates the window assembly of FIGS. 1 through 4 in which the window is pivotally moved to an open position permitting the flow of air through that window assembly, and in which the pivotally movable cover is positioned to substantially block vision through the window.

### DESCRIPTION OF PREFERRED EMBODIMENTS

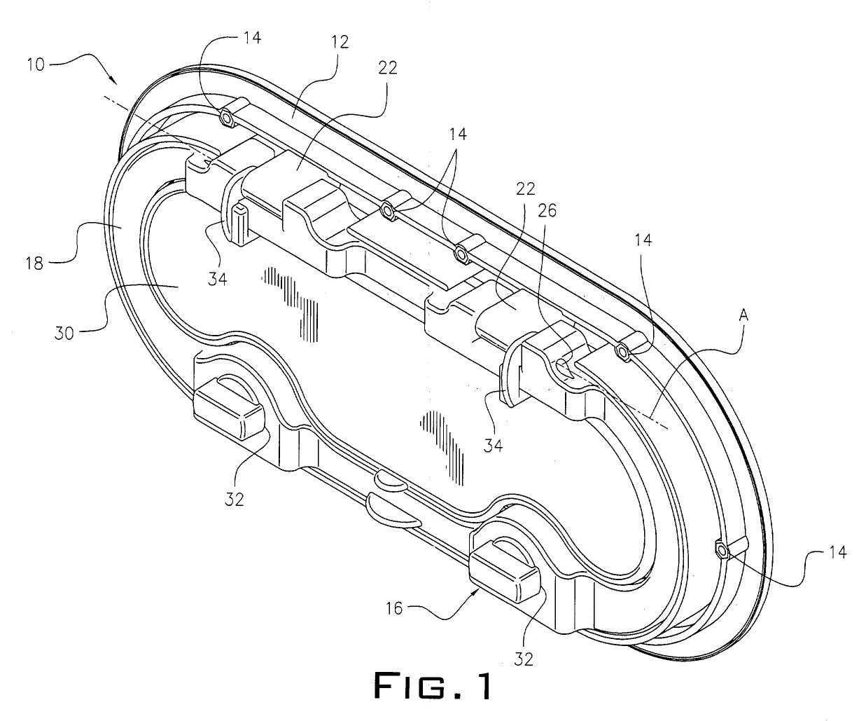

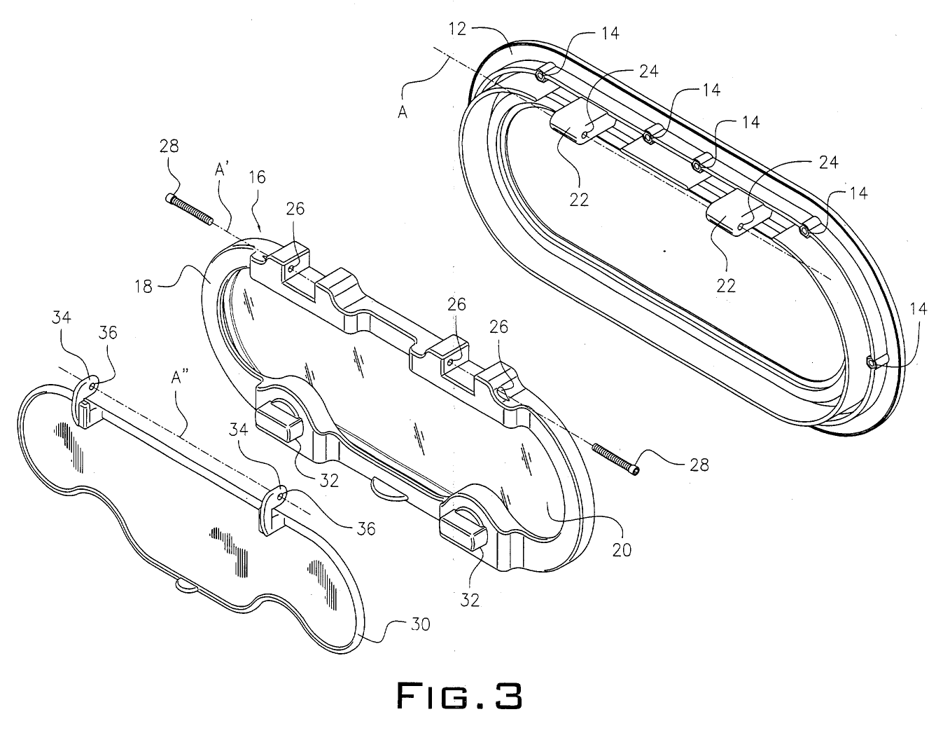

One preferred embodiment of the present invention is illustrated in the drawings, and is most conveniently seen with respect to FIGS. 1 and 3. This assembly, generally indicated by reference number 10, comprises an outer frame 12 of predetermined perimeter configuration. In this embodiment, it is conveniently illustrated having a perimeter configuration of a “racetrack” form in which two generally semicircular end portions are joined by intermediate, generally linear portions. Numerous other perimeter configurations, including rectangular, oval, round or any other convenient form may also be used with equal utility.

This frame is attachable to a vessel hull in the conventional and well known manner, conveniently using threaded fasteners screwed into structures such as threaded bosses 14 to retain the frame in place. However, the manner of mounting the frame to the hull forms no part of this invention, and any conventional manner of structure and method may be used.

In the frame 12 is mounted a window 16. Conveniently, this window may comprise a frame 18 within which is mounted a transparent member 20, suitably of glass or a rigid, substantially transparent synthetic resin. The transparent member 20 preferably is bonded within the frame 18. A portion of that frame 18 may provide for a pivotal mounting of that window 16 to the outer frame 12. The pivotal mounting may conveniently comprise mounting members 22 connected to, and suitably made integral with, the frame 12, each having collinear holes or bores 24 therethrough. These holes or bores 24 are suitably aligned on axis A.

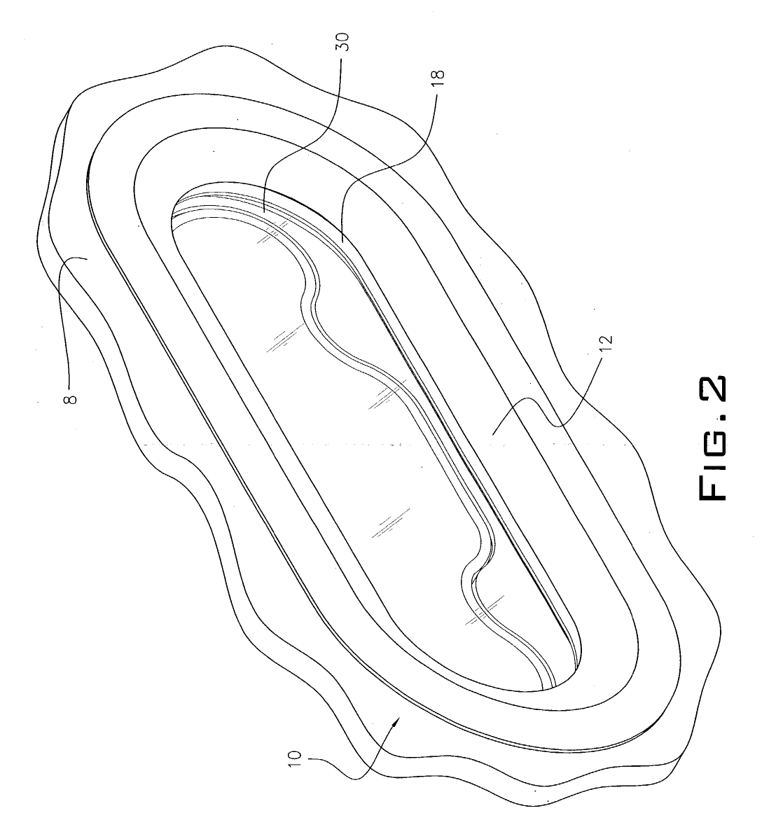

The window 16 also has pivotal mounting structure, suitably in the form of holes or bores 26 that are aligned along axis A′. The window frame 18, and thus the entire window structure 16, is mounted to the frame 12 by suitable pivot members 28 (FIG. 2) inserted through the apertures 24 and 26, thus pivotally securing the window 16 to the outer frame 12. Suitably, both the outer frame 12 and the window frame 18 may be formed of a rigid material, such as aluminum, stainless steel, or other suitable metal, or a rigid synthetic resin, which conveniently may be a polycarbonate, or acrylic.

The window 16 is also provided with latching structure for latching the window 16 to the outer frame 12 to hold the window closed, when desired. This latching mechanism may be of any suitable structure well known in the vessel window field, and may be rotatably actuated by rotation of knobs 32 to bring latching structure into contact with a portion of the outer frame 12 and thus hold it firmly closed, while being selectively releasable for opening the window.

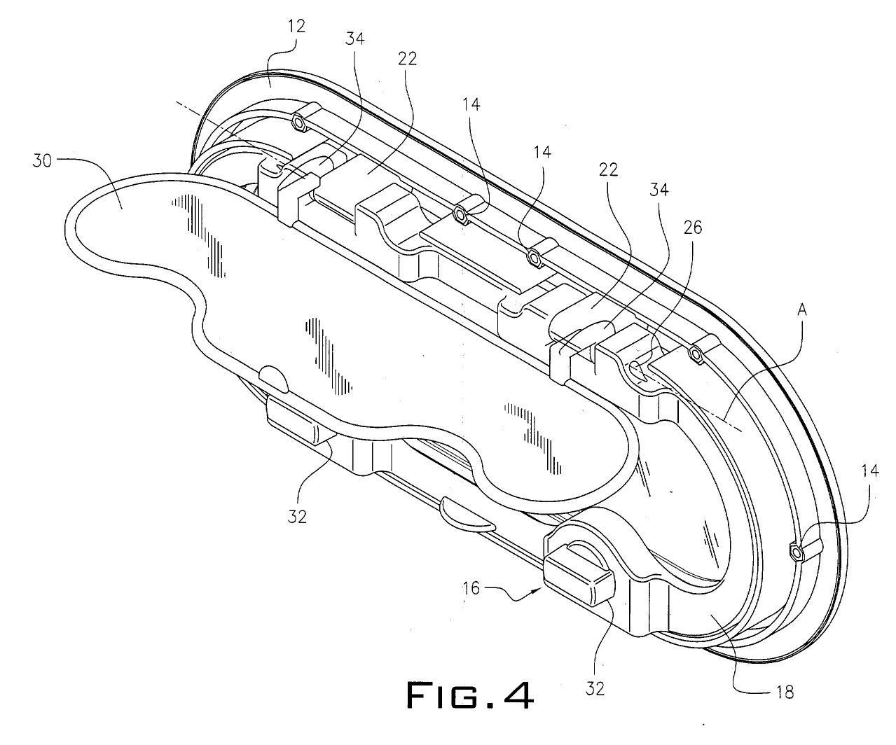

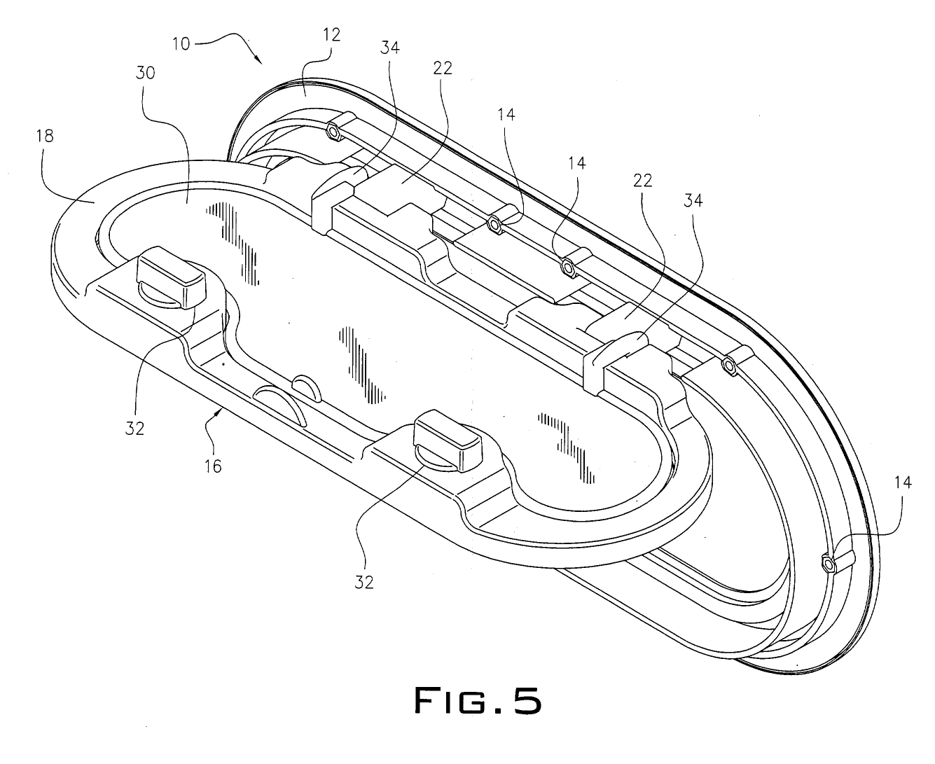

In addition to the structure described above, the window assembly of this invention also includes the cover member 30, suitably formed of rigid, substantially opaque material, which conveniently may be a rigid and substantially opaque synthetic resin. This cover 30 configured to extend over a substantial portion of the surface of the window, suitably extending over substantially all of the transparent member 20. This cover 30 includes pivotal mounts 34, shown in FIG. 2 and suitably formed integrally with the cover 30. These mounts 34 include apertures 36 that are coaxial, along axis A″. As best shown on FIGS. 1 and 4, the cover 30 is mounted to the window, suitably by aligning the apertures 36 with the window apertures 26 prior to insertion of the pivot members 28, so that the cover 30 is pivotally mounted to the frame for pivotal movement about the axis A (or A′, or A″, all of which are mutually coaxial in the completed window assembly). In this manner, the cover 30 may be selectively positioned by such pivotal movement between a first position substantially blocking vision through the window, as shown in FIGS. 1 and 5, and a second position permitting generally unobstructed vision through the window, as shown in FIG. 4. This cover 30 may be formed of any suitable, substantially rigid material, such as aluminum or other metals, or may preferably be formed by molding from a rigid, opaque, synthetic resin, or by applying fabric over a frame formed of metal or synthetic resin.

Some of the significant benefits of the window assembly of this invention may be seen in the preferred embodiment illustrated in FIGS. 1, 4 and 5, in which both the cover 30 and the window 16 are illustrated in a closed position in FIG. 1, a position in which the window 16 is closed but the cover 30 open in FIG. 4 and an illustration, in FIG. 5, in which the cover is positioned overlying the transparent portion of the window 16, but with that window 16 opened, which may suitably permit passage of air through the open window assembly. With this structure, it may be seen that the cover 30 provides for privacy, by selectively blocking or permitting vision through the transparent portion of the window.

While a particularly preferred embodiment of the apparatus of this invention has been described in detail above, it is to be understood that this description is illustrative only of the principles of the invention and is not to be considered limitative thereof. Accordingly, since numerous variations and modifications of the structure of this invention will readily occur to those skilled in the art, the scope of this invention is to be limited solely by the claims appended hereto.

What is claimed is:

1. A window assembly for a vessel, said assembly comprising
a frame of predetermined perimeter configuration
a window mounted within said frame, with one surface of said window facing in a outward direction and another surface facing in an inward direction, and
a pivotally movable cover extending over at least a substantial portion of said inward facing surface of said window and being selectively positionable for pivotal movement about a pivot axis between a first position substantially blocking vision through said window and a second position permitting generally unobstructed vision through said window.

2. The window assembly of claim 1 wherein said cover is mounted to said frame.

3. The window assembly of claim 1 wherein said window is pivotally mounted within said frame for selective movement about the pivot axis between a first closed position and a second open position.

4. The window assembly of claim 3 wherein said cover is pivotally mounted to said frame for pivotal movement about a pivot axis.

5. The window assembly of claim 4 wherein said cover is pivotally mounted to said frame generally coaxially with said window pivot axis.

6. The window assembly of claim 1, wherein said window has a perimeter configuration corresponding generally to the perimeter configuration of said frame.

7. The window assembly of claim 6 wherein said cover is of generally the same perimeter configuration as said perimeter configuration of said window.

8. The window assembly of claim 1 wherein said cover is formed of a substantially rigid synthetic resin.

9. The window assembly of claim 1 wherein said cover is formed of a generally opaque synthetic resin.
